(19) United States
(12) Patent Application Publication
(10) Pub. No.: US 2005/0123466 A1
(43) Pub. Date: Jun. 9, 2005

(54) Continuous, non-fluidized, petroleum coking process

(76) Inventor: Douglas W. Sullivan, Houston, TX (US)

Correspondence Address: MACHETTA LAW FIRM, P.C, 14614 FALLING CREEK DRIVE, HOUSTON, TX, 77068, US

(21) Appl. No.: 10/730,417

(22) Filed: Dec. 8, 2003

(51) Int. Cl. C01B 31/00

(52) U.S. Cl. 423/445 R

(57) ABSTRACT

This coke process is a continuous, non-fluidized, operation. This coke process is environmentally friendly due to its closed circuit operation, eliminating coke particulate emissions, hydrocarbon release and water pollution release into the atmosphere. This process utilizes a flash vessel and reactor agitation system in combination to prevent the buildup of coke and eliminate traditional decoking operations. Within the reactor vessel, the mixing and kneading of the hydrocarbons is critical and occurs to promote devolatilization, carbonization and forming of coke. In addition, a significant reduction in steam usage is achieved. Cokes containing low volatile combustible materials are produced. The coke is then cooled and can be safely and easily transported to storage as solid granules or as a slurry.

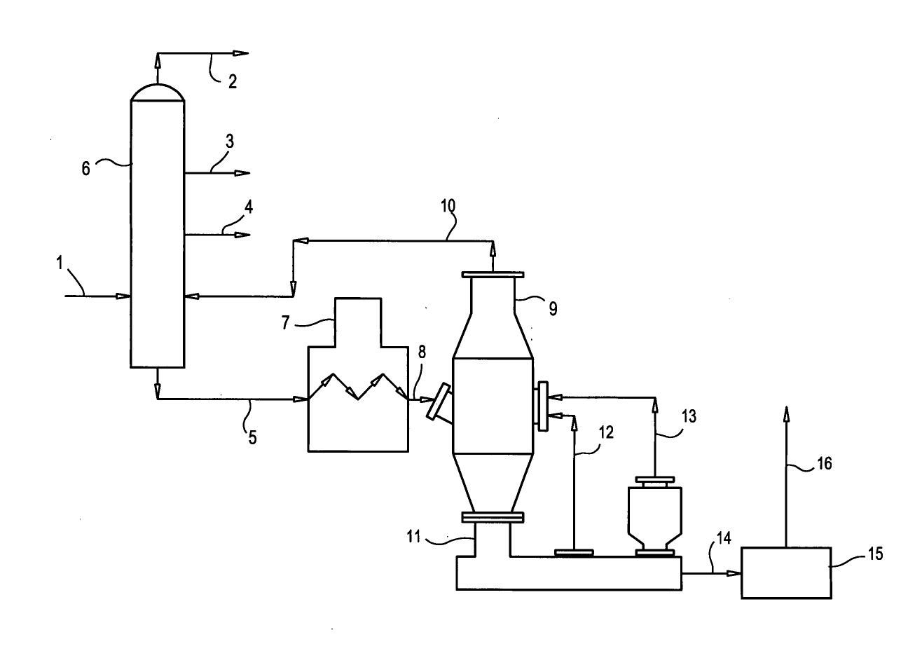

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING” A TABLE, OR A COMPUTER PROGRAM LISTING APPENDIX SUBMITTED ON A COMPACT DISC

Not Applicable

### FIELD OF THE INVENTION

This invention relates to a process for producing coke, and more particularly to a continuous, nonfluidized, petroleum coking process.

### DESCRIPTION OF RELATED ART

Petroleum residuum is the part of the crude oil that remains after distilling out low boiling components such as naphtha, kerosene, heating oil and heavy gas oil. The residuum is solid at room temperature but liquid at high temperature. It has an initial boiling point of 1050°-1100° F. at atmospheric pressure and is too heavy to be taken overhead in conventional vacuum stills.

The most widely used processes for upgrading residuum rely upon some form of thermal conversion, wherein the heavier oils are converted to lighter ones by thermal decomposition at elevated temperatures. These include Fluid Coking, Flexicoking, Delayed Coking as well as the Lurgi Coking Process.

Fluid coking and Flexicoking are two versions of a fully continuous process for thermally cracking residuum to make gas, naphtha, gas oil and coke. The basic fluid coking process has been in commercial operation for many years whereas Flexicoking is an advanced process that integrates fluid coking with coke gasification. The Lurgi Coking process is a variation of the Fluid Coking process.

Fluid Coking Process

A conventional fluid coking process includes two fluid bed vessels, a reactor and a burner, with coke particles circulating between them. Residuum feed is injected through multiple feed nozzles into the reactor where it cracks to a wide range of vapor products and a heavy “gross coke” product which deposits on the circulating particles. The cracking reaction heat is supplied by the circulating coke stream, which has been heated in the burner by combusting part of the gross coke product. A “net coke” product stream is withdrawn from the burner. Typically, a net coke product is about 20% of the residuum feed and 75% of the gross coke product formed in the reactor. The cracked vapors from the reactor leave through a single stage cyclone separator and are quenched by a liquid pumparound in the scrubber section. The heavier fractions, boiling above about 950° F., are condensed in the scrubber and are normally recycled to the reactor.

Flexicoking Process

Flexicoking is similar to fluid coking except that the coker burner is replaced by a heater and gasifier system. The reactor heater is supplied by a coke stream, which circulates between the reactor and the heater vessel. A portion of the gross coke product that consists of heavy hydrocarbons deposited on the coke is thermally cracked in the heater, yielding a C4 gas product plus residual coke. The remainder of gross coke is transported to the gasifier where it is reacted at an elevated temperature with steam and oxygen (from air), yielding a coke gas which is a mixture of CO, CO2, H2, H2O, N2 and H2S. The coke-gas, and some entrained coke particles are returned to the heater where they are cooled to release part of the heat, which is then carried back to the reactor. A hot solids stream from the gasifier transfers the balance of the reactor heat from the gasifier into the heater. The coke-gas product, after scrubbing to remove H2S, is a low sulfur fuel gas that can be burned in stream boilers, process furnaces or gas turbines. Flexicoking typically converts 98% of a vacuum residuum to gaseous and liquid products.

Delayed Coking Process

The feed to the delayed coking process consists of atmospheric or vacuum residuum and is introduced into a fractionator where it is heated and the lower boiling fractions flash off. The fractionator bottoms, including a recycle stream of heavy product, are heated in a furnace to cracking temperature (900° F.-950° F.). The heated oil enters a soaking drum that provides the long residence time needed for cracking, coking, purging, cooling and decoking. Cracked product vapors leave at the top, and coke deposits in the drum. To achieve a semi-continuous operation, at least two drums are used: one is being decoked, while the other is on-stream (coking).

One coking drum may operate for a day before it becomes filled with coke. After a drum is full, it receives a steam purge for several hours for the purpose of extracting volatile hydrocarbons from the solid mass of coke. Following the steam purge, the drum is filled with water to cool the coke. The drum is then cleaned hydraulically, using high-pressure water jets to dislodge the coke from the drums. The clean decoked drum is ready to go back on-stream by the time the other one is full of coke. Wet coke chunks from the cleaning/decoking steps are discharged to open pits then moved to an open-air storage area.

Lurgi Coking Process

The Lurgi process upgrades heavy oil and highly viscous residues by (a) heating the petroleum with hot coke particles and (b) coking the heated residue/coke mixture in a fluidized bed. The coking process produces gas, LPG, naphtha, gas oil and coke suitable for power plant fuels.

The Lurgi coking process is a thermal conversion of residue, which is obtained by using heat transferred to the feedstock by mechanical mixing with recycled hot coke particles (1100° F. to 1300° F.). Fresh feed enters the reactor, a radial mixer, where feed contacts hot coke particles. Vapor residence time is very short (less than one second), so that product yield is high and product dehydration is low. Coking occurs primarily in the cooking drum (930° F.-1100° F.). Gas and vapor products exit from the mixer for condensation and fractionation. The lift pipe recycles some of the hot coke to furnish heat for cracking reactions. Heat from effluent gas is recovered, and coke is conditioned before discharge.

The Lurgi coking process utilizes a vessel with agitator for heating the viscous petroleum residuum with hot coke particulates (the hot coke is the heating medium). That is to say, the Lurgi chamber is used for only heating of the residuum prior to performing the coking step in a fluidized bed coking process.

Problems with Delayed Coking

Delayed coking is the predominant technology used to produce petroleum coke, but there are a number of disadvantages with current delayed coking processes. These disadvantages can be briefly summarized as follows:

A) Environmental Emissions of Coke Particulates into the Atmosphere

The removal of coke from the coking drum is accomplished by using a mechanical drill, reamer, and/or using a hydraulic system comprising of a number of high-pressure (2000-2500 psig) water jets. The majority of the coke is cut from the drum and dumped onto a concrete basin that is open to the atmosphere. During the cutting process volatile vapors escape into the atmosphere through the open top and bottom flanges. The coke is loaded by front end loaders and transported to storage by conveying belts for ultimate open air storage. Coke removal from the coking drum produces coke in large chunks and smaller sizes down to fine coke particulates. Coke handling by this method results in hydrocarbon gases and particulate emissions into the atmosphere.

B) High Volatile Combustible Materials Concentration in Coke Produced from Current Delayed Coker Processes

Delayed coker operating conditions typically produce green coke containing 8% to 15% of volatile combustible matter. The stripping steam travels through channels in the coke mass but without access to all the volatiles that are trapped inside the solid mass of coke. Therefore, these substantial quantities of VCM remain unrecovered by the stripping steam.

C) Batch Operation or Semi-Continuous Operations

Coke in the delayed coking process is produced in coking drums. Two or more coking drums are used alternatively in a semi-continuous operation. The operating time for each batch of coke production is typically 48 hours, although some refineries are now shortening the cycle which causes higher volatile content in the coke.
d) Lengthy Coking Cycle

Coke production in the delayed coker process consists of two major steps, coking and removal of coke products from the coke drum, (called decoking in the coking plants). The coke operation steps in a typical delayed coker plant are described below:

| Operation | Time(hours) |
|---|---|
| Coking | 24 |
| Decoking: | 24 |
| Switch drums | 0.5 |
| Steam, cool | 6.0 |
| Drain, unhead, decoke | 7.0 |
| Rehead, warm-up | 9.0 |
| Spare time, contingency | 1.5 |

E) Coking Temperature within the Coking Drum is Inconsistent

In a delayed coker, the feed to the coking drum is heated in a fired furnace to 900 degrees Fahrenheit to 930 degrees Fahrenheit and pumped into the coking drum. Cracking reactions are endothermic causing cooling of the material in the coking drum to 820° F.-870° F. The temperature gradient varies from the bottom to the top of the drum, thus introducing variation in the coke quality.

F) Delayed Coker Produces Sponge Coke, Needle Coke and Frequently Poor Quality Shot-Coke

Petroleum coke is composed of precipitated asphaltenes and resins. Asphaltenes are high molecular weight (Over 1000) polycondensed aromatics, dispersed in the paraffinic and lighter aromatic fraction of the petroleum residuum. When the lighter paraffinic molecules are thermally cracked and vaporized in the coking drum, the asphaltenes agglomerate and precipitate out of the solution. Precipitated cokified asphaltenes form into hard spherical particles.

G) The Volatile Combustuble Material (VCM) in the Coke from the Delayed Coker Process is Highly Aromatic

The volatile combustible material heavy oil produced in the delayed coker process is aromatic and is partially composed of polycondensed aromatics (also called polynuclear aromatics, PNA). PNA are known to be highly carcinogenic. Exposure of operators to these PNA may cause serious health concerns.

The Nature of Volatile Combustible Materials in Coke

The volatile combustible materials (VCM) in the petroleum coke produced by the delayed coking process consists of hydrocarbon molecules trapped by the solidifying coke processes inside the coke matrix. This is partly due to poor mass transfer of vapors through the coke matrix due to the absence of mixing in the delayed coker-coking drum. The recovered VCM is only slightly soluble in toluene. This may also be due to the very high molecular weight of the VCM, or it may also contain high polar atoms (oxygen, nitrogen and sulfur).

Research has shown that by using the standard toluene extraction test method by refluxing crushed coke with toluene at atmospheric pressure yields only 8% of the VCM present in the coke. In a separate experiment where nitrogen is blown through the crushed coke heated at 572° F., a yellowish/greenish heavy oil was recovered in 4% yield.

These two experiments illustrate that the VCM present in the coke can be removed and/or reduced by using an appropriate method, temperature and pressure. VCM in petroleum coke is determined by measuring the volatile materials at 950° F. in a reducing atmosphere.

Agitation Systems

A number of processes not related to petroleum coking utilize equipment comprising a horizontal chamber equipped with an agitating system of varying designs which provide mixing/kneading at reduced pressure, and relatively low temperature up to 450° F. None of these are designed or used for coking of high viscosity residues at high temperature (850° F. to 1000° F.). The high temperature is absolutely required for carbonization and coking. This type of equipment is mainly used for lower temperature processing. Examples of these processes include devolatilization, drying, melting, condensation reactions, dispersing, kneading, degassing, compounding and depolymerizing.

### BRIEF SUMMARY OF THE INVENTION

A process for the continuous processing of high viscosity petroleum residuum into cokes containing low volatile combustible material.

The process comprises the following steps:
(a) Providing a means for heating the petroleum residuum at 850° to 1100° F. to induce cracking, carbonization and devolatilization under moderate or reducedpressure.
(b) Transferring the resulting heated petroleum residuum to a Flash Vessel,
(c) Allowing for flashing of vapors in said Flash Vessel,
(d) Removing the remaining liquid petroleum residuum from near the bottom of said Flash Vessel,
(e) Vigorous mixing and kneading for efficient release of the volatile hydrocarbons. This will provide for excellent homogenization for efficient heat and mass transfer to minimize shot-coke formation.
(f) Cooling of the resulting product to a temperature of 100-250 degrees F. indirectly through either air or closed circuit cooling water, and
(g) Transporting of the cooled, dry product coke granules into storage can be by dilute or dense phase pneumatic transfer by closed circuit air or inert gas.
(h) Alternatively, the hot coke particles may be directly cooled with water, then the cooled coke can be transported in a water slurry.

The novel method for coke production is especially suited for the continuous processing of high viscosity petroleum streams such as petroleum residues, heavy crude oils (both in the production fields and the refinery) and refinery waste materials.

Advantages of the Continuous, Non-Fluidized, Petroleum Coking Process

This process has the following advantages and improvements over the existing delayed coker processes:
1) This process is a continuous process;
2) This process produces coke with reduced volatile combustible material;
3) This process is a closed system and thus prevents the emissions of VCM and coke particulates into the atmosphere;
4) This process uses an efficient mixing and kneading system thereby providing uniform heat and mass transfer through the heated mixture thereby enhancing VCM reduction and reducing shot-coke production;
5) This process produces a homogeneous coke in the form of small granules that may be easily cooled, conditioned and transported in a closed system;
6) This process allows for flashing a significant amount of the vapors in the flash vessel prior to the reactor and allowing only minimal residence time in the flash vessel which inhibits solidification of the coke and the difficulty of removal of the coke from flash drums;
7) This process uses an efficient mixing system; therefore, it allows the addition of chemical additives to influence the heated mixture plasticity, morphology, sulphur content, and heavy metals content;
8) This process requires no addition of antifoaming agents in the reactor because foam breaking is achieved by the agitator action. Foaming is a common problem in the existing delayed coker processes that utilize coke drums that require the injection of silicon antifoaming chemicals;
9) The finished coke product produced by this process is free flowing, small granular pieces, which can be easily cooled, conditioned, transported and stored. In comparison, the coke produced by the delayed coker is in large, non-uniform chunks that are difficult to transport and require conditioning prior to use as a fuel.
10) The coke product may be produced without addition of water and thus the coke is completely dry.
11) Only minimal steam usage would be necessary to minimize coking in the heater. No steam is required for volatiles removal.

### BRIEF DESCRIPTION OF THE SEVERAL VIEWS OF THE DRAWING(S)

A schematic representation of the coker process is shown in the drawing.

### DETAILED DESCRIPTION OF THE INVENTION

The feed for this process 5 is the bottom stream from the delayed coker fractionator Vessel 6. Vessel 6 is a delayed coker fractionator providing overhead stream 2 as naphtha and side streams 3 Light Gas Oil and Side Stream 4 Heavy Gas Oil. The petroleum residuum 5 is fed to 7, a means for heating, to increase the temperature of the petroleum residuum to a range of about 850 to 1000 degrees Fahrenheit. The process stream 8 is then transferred to a vessel 9. The vessel 9 allows significant amount of gas vapors to be released prior to the liquid/solid material entering the reactor vessel. This flash vessel 9 position, prior to the reactor 11, is critical to enabling the reactor vessel to work effectively.

Release of the lighter hydrocarbon vapors 10 takes place as soon as the feed enters the Flash Vessel 9 and is sent returning to the fractionator unit 6. The bottoms of vessel 9 are then fed to a reactor vessel 11. This coker process utilizes a reactor vessel 11 equipped with a single shaft or a two-shaft mixer/kneader device for coking high viscosity petroleum derived materials. Further evolution of hydrocarbon vapors produced by the cracking of the feed takes place continuously along the length of the reactor vessel and vapors 12 are removed and sent back to the Vessel 9. The free space for vapors inside the reactor vessel 11 should be 25% to 60% of the total internal volume.

The viscous feed containing some solids passes through the reactor vessel 11, releasing vapors as it travels. 13 vapors are filtered to remove coke particles. Coke is produced by carbonization reactions as the feed travels through 11 until only solid coke particles remain 14. The reactor vessel 11 will operate at moderate pressure or reduced pressure, the selection of the appropriate pressure will depend on the feedstock, operating conditions and type and characteristics of the coke product desired.

When coking reactions are completed, the coke product 14 is removed at the end of the reactor vessel and a means for cooling 15 is provided where the resulting coke 14 is cooled with either cold water or air. The coke product is finally cooled to 100 to 250 degrees F. The cooled finished coke product 16 is then transported for example by using a pneumatic transporter to a storage silo. The whole coke transport system is operated under a blanket of inert gas. Alternatively, the hot coke may be cooled by a direct water quench. Compressed inert gas is continuously circulated from the coke cooling means 15 and coke transporter to the coke storage silo.

In retrofitting delayed cokers with this process, the coke drums can be used as the flash vessel or for finished coke storage or they could operate as a delayed coker in parallel with the reactor vessel.

It is also possible for the coke produced by this process to be sent to an open-air storage area after the coke has been cooled. Since essentially all the VCM has been removed from the coke, the VCM emissions would be minimal.

This invention relates to a coking process for the production of various types of petroleum coke from viscous feedstocks, such as heavy crude oils, petroleum residuum and tar sands. This coker process is a continuous operation. This coker process is environmentally friendly due to its closed circuit operation, eliminating coke particulate emissions, water pollution and hydrocarbon release into the atmosphere.

In addition, the agitation system design is important in the efficient coking of highly viscous petroleum products. The agitation system is selected to produce an intensive mixing/kneading effect and be self-cleaning. A suitable agitation system may include continuously operating single shaft agitator or multi-parallel agitators, intermeshing as they rotate inside horizontal figure of eight housing. The multi agitators may contain at least two parallel shafts; the main agitator and the cleaning agitator. The agitator shafts should be equipped with a radial extension so that they totally clean each other's discs and bars, for efficient self-cleaning and continuously scraping the viscous residuum and coke from the reactor surfaces.

During the coking of viscous petroleum products, and as a result of vaporization of lighter hydrocarbons, the remaining mixture passes through a highly viscous, plastic phase. This requires the reactor 11 to be of a rugged construction and use high torque agitation to overcome the viscous phase and provide effective mixing/kneading and solids size reduction.

This coker process utilizes a closed design system that permits processing under vacuum or pressure and the processing of wastes and toxic materials with no emissions of gases, solid particulates or toxic material to the atmosphere.

This process is suited for use in new coking plants or to replace coking drums in the commercial delayed coking process. This coker process is designed primarily for coking of heavy viscous chemical or petroleum streams or refinery waste. The reactor can also be used as a high temperature reactor that can operate at high or reduced pressure for processing other materials. Some of the processes include devolatilization, solvent stripping, blending, conditioning, aeration, deaeration, oxidation, halogenation, hydrodesulfurization, or other chemical reactions which require heating at elevated temperatures and efficient mixing at high or reduced pressures.

1. A process for the continuous production of coke, which comprises:
(a) providing a means for heating petroleum residuum to a temperature within the range from about 850-1000 degree F., (b) transferring the resulting heated petroleum residuum to a vessel, (c) releasing of vapors within said vessel, (d) wherein the residence time of the remaining petroleum residuum is less than 5 minutes within said vessel, transferring the remaining petroleum residuum from near the bottom of said vessel to a reactor vessel, (e) operating said reactor vessel under pressure ranging from about 4 psia to 65 psia, (f) mixing and kneading within said reactor vessel to promote devolatilization, carbonization and formation of coke, (g) providing a means for cooling the resulting coke product to a range from about 100-250 degrees F. and (h) transporting the resulting coke.

2. The process of claim 1 wherein the mixing and kneading step occurs by using a reactor vessel with a single agitation shaft and with an inlet for the remaining petroleum residuum and an outlet for the resulting coke product, and multi-vapor outlets.

3. The process of claim 1 wherein the mixing and kneading step occurs by using a reactor vessel with multiple agitation shafts, including a main agitator shaft and a cleaning agitator shaft, so that the shafts continuously scrape the resulting coke from the reactor as well as from each of the agitation shafts.

4. The process of claim 1 wherein an amount of air or oxygen may be added to said reactor vessel thereby increasing the temperature and hence the rate of cracking reactions and carbonization reactions.

5. The process of claim 1 wherein the means for cooling the resulting coke is provided with either air or closed circuit cooling water.

6. The process of claim 1 wherein the means for cooling the resulting coke is provided by applying water directly to the resulting coke and forming a coke slurry.
